(19) United States
(12) Patent Application Publication
(10) Pub. No.: US 2008/0007588 A1
(43) Pub. Date: Jan. 10, 2008

(54) RECORDING LIQUID, RECORDING METHOD USING THE SAME AND LIQUID CARTRIDGE

(75) Inventor: Yoshihiro Yoshimura, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/742,796

(22) Filed: May 1, 2007

(30) Foreign Application Priority Data
May 2, 2006 (JP) 2006-128638

(51) Int. Cl. B41J 2/175; B41J 2/015; C09D 11/02

(52) U.S. Cl. 347/20; 106/31.58; 347/86

(57) ABSTRACT

A recording liquid for use in recording on a recording medium is provided. The recording liquid is to be applied in form of droplets to the recording medium in the recording. The recording liquid includes: a solvent containing at least water and a water-soluble organic solvent; a coloring material soluble or dispersible in the solvent; a surfactant; and a defoamer containing at least one kind of branched.

### CROSS REFERENCES TO RELATED APPLICATIONS

The present invention contains subject matter related to Japanese Patent Application JP 2006-128638 filed in the Japanese Patent Office on May 2, 2006, the entire contents of which are incorporated herein by reference.

### BACKGROUND OF THE INVENTION

1. Field of the Invention

The present invention relates to a recording liquid for use in recording on a recording medium in which the recording liquid is applied in the form of droplets to the recording medium in the recording, a recording method using the recording liquid, and a liquid cartridge containing therein the recording liquid.

2. Description of Related Art

As an apparatus for ejecting recording liquid onto a recording medium, there is an ink-jet printer for ejecting recording liquid, e.g., ink onto a recording medium, such as plain paper or special paper, to print images and characters on the medium. As examples of ink-jet recording methods used in the ink-jet printer, there can be mentioned various methods including an electrostatic attraction method using the application of a high voltage, a piezo method in which mechanical vibration is applied to the recording liquid using a piezoelectric element, and a thermal jet method using a pressure caused due to bubbles generated by heating the ink, and, in these methods, the ink is ejected in the form of fine droplets and jetted and applied onto paper to form ink dots, thus printing images and characters on the paper.

The ink-jet recording method can be used in printing on various recording media including paper, and can be applied to a wide variety of uses, such as document printing for home use, ornamental image printing, signboard printing for commercial use using wide-format printers, and formation of color filters for use in color display, such as liquid crystal display.

The ink-jet recording method is being vigorously applied particularly to ornamental image printing, and hence the images and characters printed by the ink-jet recording method are required to have high quality. Further, in the ink-jet recording method, a high printing speed is essential from the viewpoint of improving the productivity. Therefore, the market strongly demands that the ink-jet recording method achieves both printing of images and characters with high quality and improvement of the printing speed.

For achieving printing of high-quality images and characters, the ink used in the ink-jet printer is required to have properties such that the ink is quickly dried after the printing, that the ink does not spread (feather) after the printing, that the ink is not mixed with another color ink, namely, the ink does not suffer color mixing, and that the ink does not cause color shading. Especially when plain paper is used, the ink has different penetrations into various types of fibers contained in the paper, and the different penetrations of the ink are likely to cause feathering or color mixing with another color ink. In addition, when plain paper is used, the ink has wettability for a sizing agent contained in the paper for lowering water absorption, and the wettability of the ink is likely to cause color shading. For preventing the occurrence of feathering, color mixing, or color shading, it is desirable to improve the ink used in the ink-jet printer in penetration of the ink into paper.

As a method for improving the penetration of the ink into paper, for example, the patent document 1 (Japanese Patent Application Publication No. S55-29546) has a description of a method in which a specific surfactant is added to the ink to lower the surface tension, thus improving the penetration of the ink into fibers in paper. The patent document 2 (Japanese Patent Application Publication No. S56-57862) has a description of a method in which a strongly basic substance is added to the ink to chemically dissolve the sizing agent or pulp material contained in paper, thus controlling the spread and absorption of dots.

As another example, the patent document 3 (U.S. Pat. No. 5,156,675) has a description of a method in which diethylene glycol monobutyl ether is added to prevent the ink from feathering. The patent document 4 (Japanese Patent Application Publication No. H05-208548) has a description of a method in which a dye of a specific type, which is insolubilized under restricted specific pH conditions (e.g., at a pH of 6.5 to 7.0), is used and the dye is insolubilized on the printed material and deposited to suppress the movement of the dye, thus preventing feathering. Further, the patent document 5 (Japanese Patent Application Publication No. 2001-152061) has a description of an ink set including a plurality of inks having different solid-liquid separation rates on paper, and has a description of a method in which ink having a higher solid-liquid separation rate is ejected and then another ink having a higher solid-liquid separation rate in the remaining inks to prevent the ink from feathering.

### SUMMARY OF THE INVENTION

However, the methods described in the patent documents 1 to 5 cannot completely prevent the occurrence of feathering, making it difficult to achieve printing of high-quality images and characters.

As another method for improving the penetration of the ink into paper, the patent document 6 (U.S. Pat. No. 5,183,502) has a description of a method in which an acetylenediol surfactant having characteristic high penetration is added to the ink to improve the penetration of the ink into a recording medium, such as plain paper, thus preventing the ink from feathering.

However, when using the acetylenediol surfactant, the ink is very likely to foam depending on the composition of the ink. In the ink-jet printer, when bubbles are present in the ink, the bubbles may go into a nozzle to inhibit the ink from being ejected, causing nozzle clogging. In the ink-jet printer, the acetylenediol surfactant contained in the ink causes bubbles in the ink, and, in addition, for example, in head cleaning for removing excess ink deposited on the nozzle surface of a nozzle sheet having formed nozzles, from which the ink is ejected, bubbles are generated upon absorbing the excess ink deposited on the nozzle surface using a cleaning roller and flow back into the ink through the nozzle, or bubbles are generated in an ink tank containing the ink and go into the ink in a flow path connecting the ink tank to the nozzle.

As a method for preventing the ink from foaming, various methods have been proposed. For example, the patent document 7 (Japanese Patent Application Publication No. 63-139963) has a description showing that a lower alkyl alcohol having 5 carbon atoms or less is added to the ink composition to achieve bubble stability.

The patent document 8 (Japanese Patent Application Publication No. 2002-348500) and patent document 9 (Japanese Patent Application Publication No. 2003-113397) have a description of a method in which an acetylenediol surfactant and a linear polyoxyalkylene alkyl ether having an HLB value of 8 to 19 and being represented by the chemical formula (3) below are added to the ink composition to achieve penetration and a defoaming effect, thus preventing generation of bubbles.
R⁵O(C₂H₄O)ₐ(C₃H₆O)_{b}(C₂H₄O)_{c}(C₃H₆O)_{d}H (3)
wherein R⁵ represents an alkyl group having 20 carbon atoms or less; a is a positive number of 1 to 20; and each of b, c, and d is 0 or a positive number of 1 to 20.

The patent document 10 (Japanese Patent Application Publication No. 2003-183548) has a description showing that acetylenediols having different ethylene oxide addition moles are used in combination to prevent the ink from foaming, enabling printing of high-quality images on plain paper.

Further, the patent document 11 (Japanese Patent Application Publication No. 2000-144026) has a description showing that an acetylenediol surfactant having a specific structure is used to prevent the ink from foaming, thus obtaining high-quality images on plain paper.

The ink using a lower alkyl alcohol or an acetylenediol surfactant described in the patent documents 7 to 11 is prevented from generating bubbles when stored in an environment at an ambient temperature; however, the present inventors have ascertained that, when stored in a high-temperature environment for a long term, e.g., during the ship transport in equatorial areas or warehousing in the summer season, the ink may not be prevented from foaming, and is likely to foaming, and thus a satisfactory defoaming effect may not be obtained when the ink is stored at a high temperature for a long term. Therefore, when the ink containing a lower alkyl alcohol or an acetylenediol surfactant described in the patent documents 7 to 11 is stored in an environment at a high temperature for a long term, bubbles are generated in the ink, and the bubbles generated may go into the ink flow path or nozzle to cause nozzle clogging, making it impossible to obtain high-quality images and characters.

Accordingly, it is desirable to provide a recording liquid which is prevented from foaming not only after stored in an environment at an ambient temperature but also after stored in an environment at a high temperature for a long term, and exhibits excellent storage stability and excellent ejection stability, and which has excellent penetration into a recording medium and hence is prevented from feathering and causing color shading, enabling recording of high-quality images and characters free of color mixing in multicolor printing, a recording method, and a liquid cartridge. The present invention is made in view of the above issues.

A recording liquid according to an embodiment of the present invention includes: a solvent containing at least water and a water-soluble organic solvent; a coloring material soluble or dispersible in the solvent; a surfactant; and a defoamer containing at least one kind of branched polymer.

A recording method according to an embodiment of the present invention includes ejecting fine droplets of a recording liquid from an ejection outlet, formed in a liquid ejection head, for ejecting the recording liquid onto a recording medium in response to a recording signal to perform recording, wherein the recording liquid includes: a solvent containing at least water and a water-soluble organic solvent; a coloring material soluble or dispersible in the solvent; a surfactant; and a defoamer containing at least one kind of branched polymer.

A liquid cartridge according to an embodiment of the present invention contains therein a recording liquid for use in recording on a recording subject, wherein the recording liquid is applied in the form of droplets to the recording subject in the recording, wherein the recording liquid contained includes: a solvent containing at least water and a water-soluble organic solvent; a coloring material soluble or dispersible in the solvent; a surfactant; and a defoamer containing at least one kind of branched polymer.

According to the present invention, by virtue of containing a surfactant and a defoamer containing at least one kind of branched polymer, the recording liquid is prevented from foaming not only after stored in an environment at an ambient temperature but also after stored in an environment at a high temperature, and hence exhibits excellent storage stability and excellent ejection stability. Furthermore, the recording liquid has excellent penetration into a recording medium and hence is prevented from feathering and causing color shading, thus enabling recording of high-quality images and characters free of color mixing in multicolor printing.

### BRIEF DESCRIPTION OF THE DRAWINGS

FIG. 1 is a perspective view showing an ink-jet printer according to an embodiment of the present invention;

FIG. 2 is a perspective view showing a head cartridge used in an ink-jet printer;

FIG. 3 is a cross-sectional view of a head cartridge.

FIG. 4 are cross-sectional views of an ink jet head formed in the head cartridge, wherein FIG. 4A is a diagrammatic cross-sectional view showing a state in which a bubble has been generated by a heating resistance element, and FIG. 4B is a diagrammatic cross-sectional view showing a state in which the ink has been ejected from a nozzle; and

FIG. 5 is a perspective side view showing the construction of an ink-jet printer.

### DETAILED DESCRIPTION OF THE INVENTION

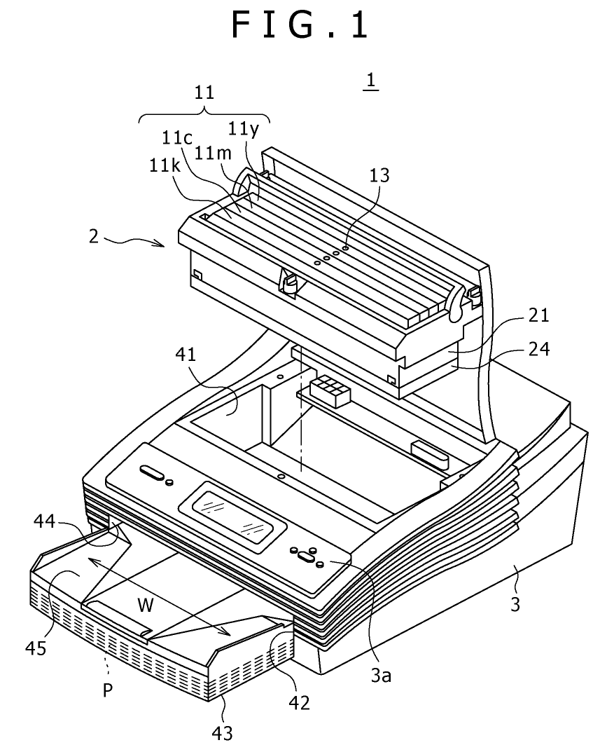

Hereinbelow, the ink, printing method, and ink cartridge according to an embodiment of the present invention will be described with reference to the accompanying drawings. The ink i of the present invention is used in, for example, an ink-jet printer 1 (herein after, referred to as “printer 1”) shown in FIG. 1. In the printer 1, color images or characters can be printed using the ink i containing inks with respective four colors, i.e., a yellow ink, a magenta ink, a cyan ink, and a black ink. In the following description, the ink i of the present invention is first described, and then the printer shown in FIG. 1 using the ink i is described.

The ink i includes a solvent containing at least water and a water-soluble organic solvent, a coloring material soluble or dispersible in the solvent, a surfactant, and a defoamer containing at least one kind of branched polymer.

As the solvent, at least water and a water-soluble organic solvent are used. Examples of water-soluble organic solvents include polyhydric alcohols, such as ethylene glycol, diethylene glycol, triethylene glycol, polyethylene glycol, polypropylene glycol, propylene glycol, butylene glycol, 1,5-pentanediol, 1,2,6-hexanetriol, thioglycol, hexylene glycol, 2-ethyl-1,3-hexanediol, glycerol, and trimethylolpropane. The water-soluble organic solvent is not limited to these solvents.

The water-soluble organic solvent is added to the ink i to impart water retention properties to the ink i. The content of the water-soluble organic solvent in the ink i is preferably 0.1 to 40% by weight, more preferably 1 to 30% by weight. In the water-soluble organic solvent, the above-listed polyhydric alcohols may be used individually or in combination.

Preferred examples of the coloring materials soluble or dispersible in the solvent include dyes, such as water-soluble dyes, disperse dyes, and oil-soluble dyes, and pigments, such as inorganic pigments and organic pigments, and, of these, especially preferred are water-soluble dyes.

Specifically, preferred examples of water-soluble dyes used in yellow ink are shown below. The water-soluble dye used in yellow ink is not limited to those shown below, and a water-soluble dye generally used in yellow ink can be used. Examples of water-soluble dyes used in yellow ink include C. I. Acid Yellow 17, 23, 42, 44, 79, 142, C.I. Food Yellow 3, 4, C.I. Direct Yellow 1, 12, 24, 26, 33, 44, 50, 86, 120, 132, 142, 144, C.I. Basic Yellow 1, 2, 11, 13, 14, 15, 19, 21, 23, 24, 25, 28, 29, 32, 36, 40, 41, 45, 49, 51, 53, 63, 64, 65, 67, 70, 73, 77, 87, 91, and C.I. Reactive Yellow 1, 5, 11, 13, 14, 20, 21, 22, 25, 40, 47, 51, 55, 65, 67.

Preferred examples of water-soluble dyes used in magenta ink are shown below. The water-soluble dye used in magenta ink is not limited to those shown below, and a water-soluble dye generally used in magenta ink can be used. Examples of water-soluble dyes used in magenta ink include C.I. Acid Red 1, 8, 13, 14, 18, 26, 27, 35, 37, 42, 52, 82, 87, 89, 92, 97, 105, 111, 114, 115, 134, 186, 249, 254, 289, C.I. Food Red 7, 9, 14, C.I. Direct Red 1, 4, 9, 13, 17, 20, 28, 31, 39, 80, 81, 83, 89, 225, 227, C.I. Basic Red 2, 12, 13, 14, 15, 18, 22, 23, 24, 27, 29, 35, 36, 38, 39, 46, 49, 51, 52, 54, 59, 68, 69, 70, 73, 78, 82, 102, 104, 109, 112, and C.I. Reactive Red 1, 14, 17, 25, 26, 32, 37, 44, 46, 55, 60, 66, 74, 79, 96, 97.

Preferred examples of water-soluble dyes used in cyan ink are shown below. The water-soluble dye used in cyan ink is not limited to those shown below, and a water-soluble dye generally used in cyan ink can be used. Examples of water-soluble dyes used in cyan ink include C.I. Acid Blue 9, 29, 45, 92, 249, C.I. Direct Blue 1, 2, 6, 15, 22, 25, 71, 76, 79, 86, 87, 90, 98, 163, 165, 199, 202, C.I. Basic Blue 1, 3, 5, 7, 9, 21, 22, 26, 35, 41, 45, 47, 54, 62, 65, 66, 67, 69, 75, 77, 78, 89, 92, 93, 105, 117, 120, 122, 124, 129, 137, 141, 147, 155, and C.I. Reactive Blue 1, 2, 7, 14, 15, 23, 32, 35, 38, 41, 63, 80, 95.

Preferred examples of water-soluble dyes used in black ink are shown below. The water-soluble dye used in black ink is not limited to those shown below, and a water-soluble dye generally used in black ink can be used. Examples of water-soluble dyes used in black ink include C.I. Acid Black 1, 2, 7, 24, 26, 94, C.I. Food Black 1, 2, C.I. Direct Black 19, 22, 32, 38, 51, 56, 71, 74, 75, 77, 154, 168, 171, C.I. Basic Black 2, 8, and C.I. Reactive Black 3, 4, 7, 11, 12, 17.

Examples of inorganic pigments include titanium oxide, iron oxide, and carbon black. Examples of organic pigments include azo pigments (such as azo lakes, insoluble azo pigments, condensed azo pigments, and chelate azo pigments) polycyclic pigments (such as phthalocyanine pigments, perylene pigments, perynone pigments, anthraquinone pigments, quinacridone pigments, dioxane pigments, thioindigo pigments, isoindolinone pigments, and quinofuranone pigments), nitro pigments, nitroso pigments, and aniline black.

Examples of pigments used in black ink include Regal 400R, Regal 330R, Regal 660R, Mogul L, Monarch 700, Monarch 800, Monarch 880, Monarch 900, Monarch 1000, Monarch 1100, Monarch 1300, and Monarch 1400, all of which are manufactured and sold by Cabot Specialty Chemicals Inc. The pigment used in black ink is not limited to these pigments.

Examples of pigments used in yellow ink include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 114, C.I. Pigment Yellow 128, C.I. Pigment Yellow 129, C.I. Pigment Yellow 151, and C.I. Pigment Yellow 154. The pigment used in yellow ink is not limited to these pigments.

Examples of pigments used in magenta ink include C.I. Pigment Red 5, C.I. Pigment Red 7, C.I. Pigment Red 12, C.I. Pigment Red 48 (Ca), C.I. Pigment Red 48 (Mn), C.I. Pigment Red 57 (Ca), C.I. Pigment Red 57:1, C.I. Pigment Red 112, C.I. Pigment Red 122, C.I. Pigment Red 168, C.I. Pigment Red 184, and C.I. Pigment Red 202. The pigment used in magenta ink is not limited to these pigments.

Examples of pigments used in cyan ink include C.I. Pigment Blue 1, C. I. Pigment Blue 2, C. I. Pigment Blue 3, C. I. Pigment Blue 15, C.I. Pigment Blue 15:3, C.I. Pigment Blue 15:34, C.I. Pigment Blue 16, C.I. Pigment Blue 22, C.I. Pigment Blue 60, C.I. Vat Blue 4, and C.I. Vat Blue 60. The pigment used in cyan ink is not limited to these pigments.

As the pigment, preferred is a self-dispersing pigment having a hydrophilic surface by virtue of having at least one functional group selected from a carbonyl group, a carboxyl group, a hydroxyl group, a sulfone group, a sulfonic group, and a salt thereof.

As the pigment, further preferred is a microcapsule pigment produced by a known physical mechanical method or chemical method.

As an example of the defoamer, there can be mentioned at least one branched polymer. The branched polymer means a polymer having not a simple linear structure but a branching point. Examples of branched polymers include star burst polymers having a structure highly branched radially from one atom or molecule as the center, dendrimers having a structure branched symmetrically from one atom or molecule as the center, and hyperbranched polymers having a structure randomly branched from one atom or molecule as the center. In the ink i, these branched polymers can be used individually or in combination.

The branched polymer prevents the ink i from foaming, and can prevent not only the ink i stored in an environment at an ambient temperature but also the ink i stored in an environment at a high temperature from foaming. With respect to the content of the branched polymer in the ink i, even when contained in a slight amount in the ink i, the branched polymer exhibits a defoaming effect, and hence the upper limit of the branched polymer content of the ink i is 0.01% by weight. When the branched polymer content is 0.01% by weight or less, a satisfactory defoaming effect can be obtained, thus preventing lowering of the ejection properties. When the branched polymer content is 0.005 to 0.01% by weight, the defoaming effect may be saturated depending on the composition of the ink i. Therefore, the upper limit of the branched polymer content is preferably 0.005% by weight or less. The ink i has a branched polymer content as small as 0.01% by weight, and hence the branched polymer does not adversely affect the effect of the surfactant and others contained in the ink i. On the other hand, when the branched polymer content is, for example, 0.02% by weight or more, that is, when the branched polymer content is too large, the ejection stability is lowered.

As the surfactant, a surfactant generally used in ink i can be used, preferably, at least one kind of acetylenediol surfactant represented by the following chemical formula (1) or (2) is used. 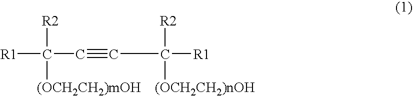
wherein each of R¹ and R² independently represents an alkyl group having 1 to 5 carbon atoms, and the following relationships are satisfied: 0<m≦25, 0<n≦25, and 0<m+n≦40. 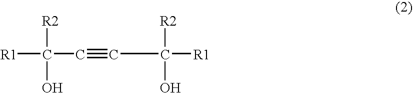
wherein each of R¹ and R² independently represents an alkyl group having 1 to 5 carbon atoms.

As a surfactant other than the acetylenediol surfactant, a nonionic surfactant, anionic surfactant, or amphoteric surfactant can be used, and especially preferred is a nonionic surfactant.

Specific examples of nonionic surfactants include ethylene oxide addition-type surfactants, such as polyoxyethylene alkyl ether, polyoxyethylene alkyl phenyl ether, polyoxyethylene alkyl ester, and polyoxyethylene alkyl amide; polyol ester-type surfactants, such as glycerol alkyl ester, sorbitan alkyl ester, and sugar alkyl ester; polyether-type surfactants, such as polyhydric alcohol alkyl ether; and alkanol amide-type surfactants, such as alkanolamine fatty acid amide.

Specific examples of anionic surfactants include fatty acid sodium salt, fatty acid potassium salt, sodium alkylsulfate, triethanolamine alkylsulfate, ammonium alkylsulfate, sodium alkylbenzenesulfonate, sodium alkylalkylnaphthalenesulfonate, sodium dialkylsulfosuccinate, sodium alkyl diphenyl ether disulfonate, potassium polyoxyethylene alkylphosphate, sodium polyoxyethylene alkyl ether sulfate, triethanolamine polyoxyethylene alkyl ether sulfate, sodium polyoxyethylene alkyl ether acetate, and sodium alkanesulfonate.

Specific examples of amphoteric surfactants include alkyldimethylcarboxymethylbetaine, alkylamide propylbetaine, alkylhydroxysulfobetaine, 2-alkyl-N-carboxymethyl-N-hydroxyethylimidazolinium betaine, and alkyldimethylamine oxide.

The surfactant permits the ink i to smoothly penetrate various fibers constituting recording paper P to prevent the ink i from feathering, making it possible to prevent the ink i from mixing with another color ink i in multicolor printing. In addition, the surfactant improves the ink i in wettability for the sizing agent contained in the recording paper P for lowering water absorption, thus preventing the ink i from causing color shading. Particularly, the acetylenediol surfactant represented by the chemical formula (1) or (2) can further improve the ink i in penetration into the recording paper P, thus more surely preventing the ink i from feathering, mixing with another color ink, and causing color shading.

The content of the surfactant in the ink i is preferably 0.01 to 5.0% by weight, more preferably 0.1 to 3.0% by weight. When the surfactant content of the ink i is 0.01 to 5.0% by weight, the ink i is improved in wettability for the recording paper P, and thus smoothly penetrates the recording paper P.

In the ink i, in addition to the coloring material, branched polymer, and surfactant, an appropriate pH adjustor may be contained. As the pH adjustor, there can be used an amine, such as monoethanolamine, diethanolamine, triethanolamine, monoisopropanolamine, diisopropanolamine, triisopropanolamine, aminoethoxyethanol, methylethanolamine, methyldiethanolamine, diethylethanolamine, or dimethylethanolamine; a hydroxide of alkali metal, such as sodium hydroxide, lithium hydroxide, or potassium hydroxide; ammonium hydroxide; quaternary ammonium hydroxide; a carbonate, such as potassium carbonate, sodium carbonate, or lithium carbonate; a phosphate; or an urea, such as urea, thiourea, or tetramethylurea. The pH adjustor is not limited to these compounds.

In the ink i having the above-described constituents, when at least one branched polymer is contained as a defoamer, the ink i is prevented from foaming not only after stored in an environment at an ambient temperature but also after stored in a high-temperature environment for a long term, e.g., during the ship transport in equatorial areas or warehousing in the summer season, thus achieving excellent storage stability. Therefore, the ink i can avoid the occurrence of problems, such as nozzle clogging due to bubbles going into the nozzle. Further, in the ink i, in addition to the defoamer, a surfactant is contained, and improves the ink i in both penetration into the recording paper P and wettability for the sizing agent, thus preventing the ink i from feathering, causing color shading, and mixing with another color ink i. From this, it is apparent that, when the ink i is used in the printer 1, the printer can achieve printing of high-quality images and characters.

When the ink i contains at least one kind of acetylenediol surfactant represented by the chemical formula (1) or (2) as a surfactant, the surfactant further improves the ink i in both penetration into the recording paper P and wettability for the sizing agent, thus more surely preventing the ink i from feathering, causing color shading, and mixing with another color ink i. From this, it is apparent that, when the ink i contains at least one kind of acetylenediol surfactant represented by the chemical formula (1) or (2) as a surfactant, it can achieve printing of higher-quality images and characters.

An ink-jet printer (herein after, referred to as “printer”) 1 using the ink i is described in detail. As shown in FIG. 1, the printer 1 includes an ink-jet printer head cartridge (herein after, referred to as “head cartridge”) 2 for ejecting the above-described ink i onto a subject of printing, e.g., recording paper P, and a printer body 3 to which the head cartridge 2 is fitted. The printer 1 is a so-called line printer in which nozzles are arranged in a substantially straight line or two or more lines extending in the width direction of the recording paper P, namely, in the direction indicated by an arrow W in FIG. 1. In the printer 1, the head cartridge 2 is detachable from the printer body 3.

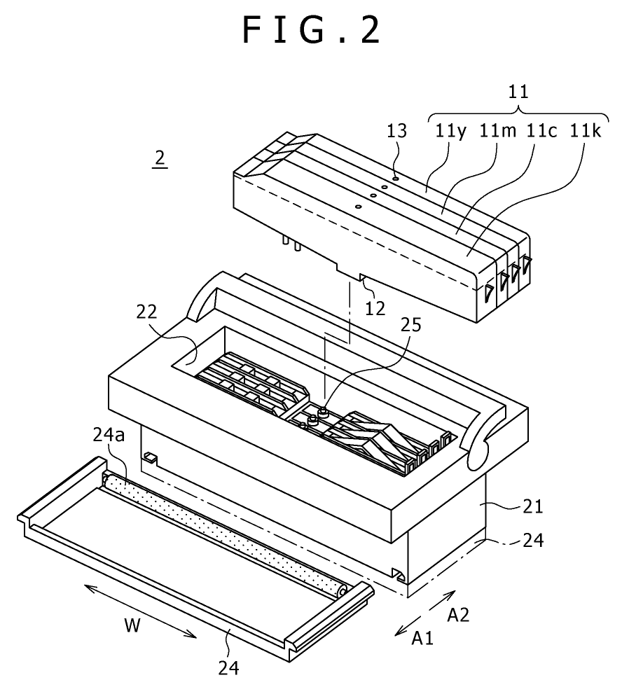

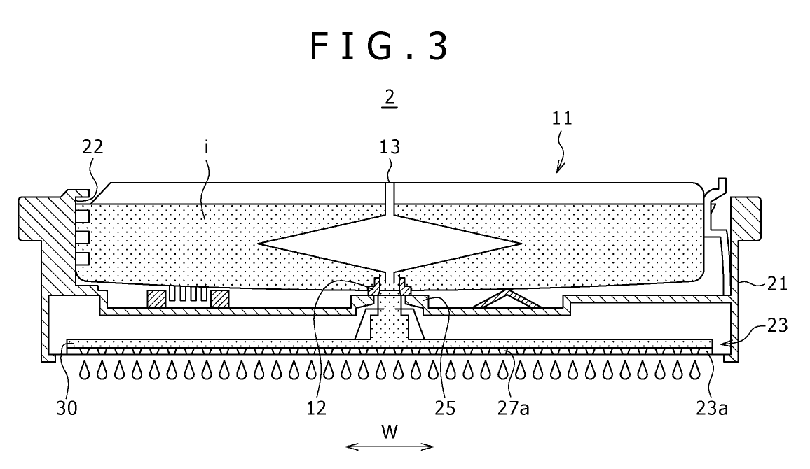

The head cartridge 2 constituting the printer 1 will now be first described. The head cartridge 2 ejects the above-described ink i using, for example, as a pressure generator element a heating resistance element employing an electro-thermal transfer method to permit the ink i to deposit onto the principal surface of the recording paper P. As shown in FIGS. 2 and 3, an ink cartridge 11 containing therein the ink i is fitted to the head cartridge 2. The ink cartridge 11 includes individual ink cartridges for respective colors, i.e., an ink cartridge 11y for yellow ink, an ink cartridge 11m for magenta ink, an ink cartridge 11c for cyan ink, and an ink cartridge 11k for black ink. The ink cartridge 11 has a substantially rectangular form having a size substantially the same as the size of the recording paper P in the width direction. As shown in FIGS. 2 and 3, the ink cartridge 11 has an ink feeding portion 12 for feeding the ink i to a cartridge body 21 of the head cartridge 2, and air communication holes 13, formed in substantially the center of the top of the ink cartridge, for introducing air from the outside after the ink i is fed to the cartridge body 21. The cartridge body 21 may be unified with the ink cartridge 11.

The ink feeding portion 12 is provided at substantially the center of the bottom of the ink cartridge 11. The ink feeding portion 12 is a nozzle in a form protruding from the cartridge, and the tip of the nozzle is fitted to the below-mentioned connecting portion 25 of the head cartridge 2 to connect the ink cartridge 11 to the cartridge body 21 of the head cartridge 2, enabling feeding of the ink. The ink feeding portion 12 has a valve mechanism, and controls the feed of the ink i to the cartridge body 21 using the valve mechanism.

The head cartridge 2 to which the ink cartridge 11 is fitted has the cartridge body 21 as shown in FIGS. 2 and 3. The cartridge body 21 has a fitting portion 22 into which the ink cartridge 11 is fitted, an ink jet head 23 for ejecting the ink i, and a head cap 24 for protecting the ink jet head 23.

At substantially the center of the fitting portion 22 is formed a connecting portion 25 to be connected to the ink feeding portion 12 of the ink cartridge 11 fitted into the fitting portion 22. The connecting portion 25 serves as an ink feed channel through which the ink i is fed from the ink feeding portion 12 of the ink cartridge 11 fitted into the fitting portion 22 to the ink jet head 23 for ejecting the ink i formed at the bottom of the cartridge body 21. The connecting portion 25 controls the feed of the ink i from the ink cartridge 11 to the ink jet head 23 using the valve mechanism.

The ink jet head 23 to which the ink i is fed from the connecting portion 25 is arranged along the bottom of the cartridge body 21. In the ink jet head 23, the blow-mentioned nozzles 27a, which are jet outlets for ejecting the ink i fed from the connecting portion 25, are arranged in a substantially straight line extending in the width direction of the recording paper P, namely, in the direction indicated by an arrow W in FIG. 3. The ink jet head 23 does not move in the width direction of the recording paper P upon ejecting the ink i and ejects the ink i per nozzle line.

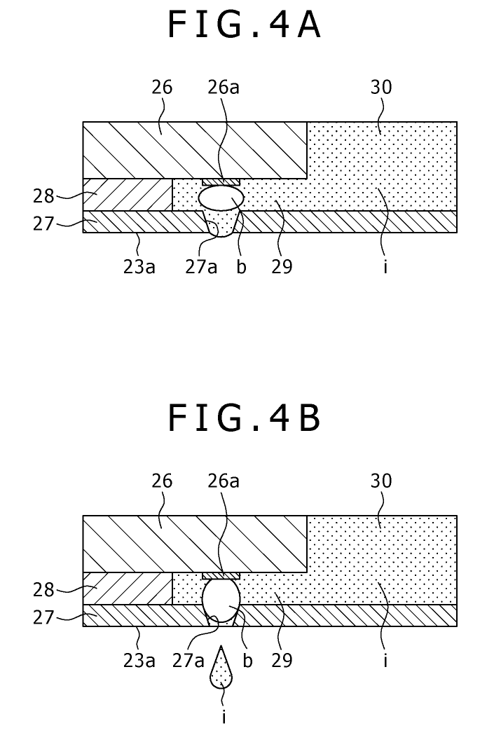

As shown in FIG. 4, the ink jet head 23 includes a circuit board 26 having formed thereon a heating resistance element 26a employing an electro-thermal transfer method, a nozzle sheet 27 having formed therein a nozzle 27a, and a film 28 disposed between the circuit board 26 and the nozzle sheet 27. The ink jet head 23 has an ink chamber 29 defined by the circuit board 26, nozzle sheet 27, and film 28. The ink chamber 29 is filled with the ink i to be heated by the heating resistance element 26a. The ink jet head 23 has formed therein an ink flow path 30 through which the ink i is fed to the ink chamber 29 from the ink cartridge 11 containing therein the ink i.

In the ink jet head 23 having the above-described construction, a control circuit of the circuit board 26 selectively supplies a pulsed current to the heating resistance element 26a in response to a recording signal based on the printing data to heat the heating resistance element 26a. In the ink jet head 23, when the heating resistance element 26a is heated, as shown in FIG. 4A, a bubble b is generated in the ink i in contact with the heating resistance element 26a. Then, in the ink jet head 23, as shown in FIG. 4B, the bubble b expands and presses the ink i, and the ink i pressed is ejected in the form of a droplet from the nozzle 27a. Further, in the ink jet head 23, after the droplet of the ink i is ejected, the ink i is fed to the ink chamber 29 through the ink flow path 30 to regain the state before the ejection. In the ink jet head 23, the above operation is repeated in response to a recording signal based on the printing data to eject the ink i onto the recording paper P, achieving printing of images and characters.

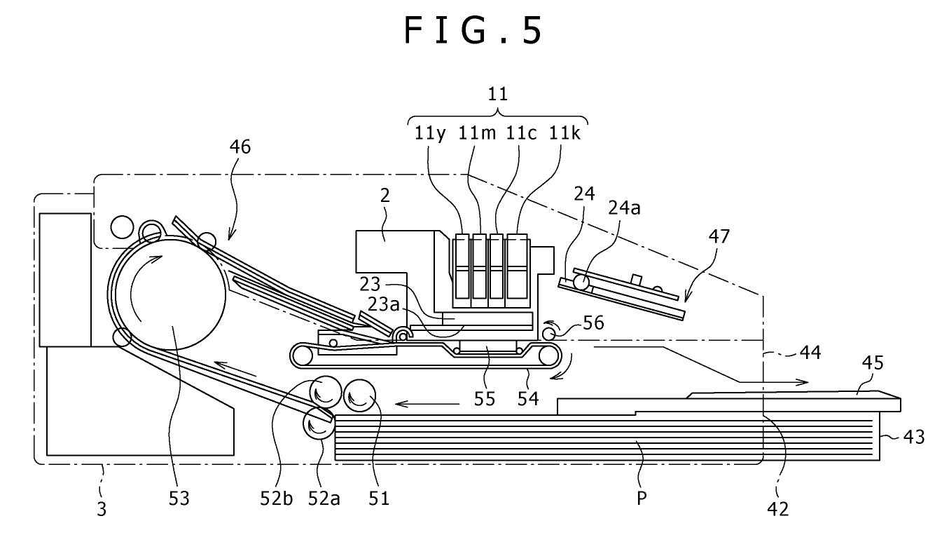

The head cap 24 for protecting a jet surface 23a of the ink jet head 23, as shown in FIG. 2, covers the jet surface 23a of the ink jet head 23 to protect the nozzle 27a from drying or the like while the ink i is not being ejected or printing is not conducted. While printing is conducted, as shown in FIGS. 2 and 5, the head cap 24 moves toward the front of the printer body 3 from the bottom of the head cartridge 2, namely, in the direction indicated by an arrow A1 in FIG. 2 to expose the jet surface 23a of the ink jet head 23. After the printing, as shown in FIG. 2, the head cap 24 moves to the bottom of the head cartridge 2 from the front of the printer body 3, namely, in the direction indicated by an arrow A2 in FIG. 2 to protect the jet surface 23a of the ink jet head 23.

The head cap 24 has a cleaning roller 24a for removing the excess ink i deposited onto the jet surface 23a. The head cap 24 cleans the jet surface 23a by means of the cleaning roller 24a upon exposing the jet surface 23a to absorb the excess ink i deposited onto the jet surface 23a. The head cap 24 may clean the jet surface 23a by means of the cleaning roller 24a upon moving toward the bottom of the head cartridge 2 after printing.

In the printer body 3 to which the head cartridge 2 is fitted, as shown in FIG. 1, the head cartridge 2 is fitted into a head cartridge fitting portion 41. The printer body 3 has a paper feed tray 43 containing a stack of recording paper P before printing provided at a paper feed inlet 42 formed in the lower portion of the front of the printer body, and a paper receiving tray 45 for receiving the printed recording paper P provided at a paper discharge outlet 44 formed in the upper portion of the front of the printer body.

The printer body 3 has, as shown in FIG. 5, a paper feeding-discharging mechanism 46 for conveying the recording paper P, and ahead cap opening-closing mechanism 47 for opening or closing the head cap 24 formed for the jet surface 23a of the head cartridge 2.

The printer 1 having the above-described construction conducts printing based on the printing data input from an information processing device provided at the outside. Specifically, in the printer 1, the head cap opening-closing mechanism 47 moves the head cap 24 in the head cartridge 2 toward the front of the printer body 3 at which the paper feed tray 43 and paper receiving tray 45 are provided, so that the nozzles 27a formed in the jet surface 23a of the ink jet head 23 in the printer 1 are exposed, enabling ejection of the ink i.

Next, in the printer 1, operating an operation button 3a provided on the printer body 3 drives the paper feeding-discharging mechanism 46 of the printer body 3, and the recording paper P is pulled from the paper feed tray 43 by a paper feed roller 51, and only one sheet of the recording paper P is pulled from the paper feed tray 43 by a pair of separate rollers 52a, 52b rotating in the same direction. In the printer 1, the recording paper P pulled from the paper feed tray 43 is reversed to the head cartridge 23 by a reversing roller 53, and the recording paper P is placed on a conveyor belt 54 facing the jet surface 23a. The recording paper P is held by a platen 55 facing the jet surface 23a of the ink jet head 23, so that the recording paper faces the jet surface 23a.

Then, the printer 1 supplies a driving current to a plurality of heating resistance elements 26a provided for respective colors at the ink jet head 23 according to a control signal based on the printing data to heat the heating resistance elements 26a. In the printer 1, as shown in FIG. 4, the heating resistance elements 26a are heated to eject the above-mentioned ink i for respective colors in the form of droplets from the nozzles 27a onto the recording paper P placed so as to face the jet surface 23a, thus achieving printing of color images and characters comprised of a plurality of colors.

Then, in the printer 1, after the droplets of the ink are ejected from the nozzles 27a, the ink i in the same amount as the amount of the ink i ejected is fed to the ink jet head 23 from the ink cartridge 11 through the connecting portion 25.

Subsequently, in the printer 1, the printed recording paper P is fed to the paper discharge outlet 44 by means of both the conveyor belt 54 traveling in the direction of the paper discharge outlet 44 and a paper discharge roller 56, which faces the conveyor belt 54 and which is formed on the side of the paper discharge outlet 44 opposite the jet surface 23a, thus discharging the printed recording paper P to the paper receiving tray 45. In this way, the printer 1 achieves printing of images and characters on the recording paper P.

In the above-described printer 1, when at least one branched polymer is contained as a defoamer in the ink i, the ink i is prevented from foaming not only after stored in an environment at an ambient temperature but also after stored in a high-temperature environment for a long term, e.g., during the ship transport in equatorial areas or warehousing in the summer season. Therefore, in the printer 1, no bubbles go into the nozzles, and hence the occurrence of problems, such as nozzle clogging, can be prevented, thus achieving excellent ejection stability.

In the printer 1, in addition to the defoamer, a surfactant is contained in the ink i, and improves the ink i in both penetration into the recording paper P and wettability for the sizing agent, thus preventing the ink i from feathering, causing color shading, and mixing with another color ink i. Thus, the printer 1 is advantageous not only in that it is free from nozzle clogging and hence has excellent ejection stability, but also in that the penetration of the ink into the recording paper P is excellent and hence feathering or color shading is prevented, enabling printing of high-quality images and characters free of color mixing in multicolor printing.

Further, in the printer 1, when at least one kind of acetylenediol surfactant represented by the chemical formula (1) or (2) is contained as a surfactant in the ink i, the surfactant further improves the ink i in both penetration into the recording paper P and wettability for the sizing agent, thus more surely preventing the ink i from feathering, causing color shading, and mixing with another color ink i. From this, it is apparent that, when at least one kind of acetylenediol surfactant represented by the chemical formula (1) or (2) is contained as a surfactant in the ink i in the printer 1, the printer can achieve printing of higher-quality images and characters.

The present invention is described above using the line printer 1 as one example of the embodiment, but the present invention is not limited to the printer of this type, and can be applied to a serial printer which performs printing for one line by moving an ink jet head in the width direction of the recording paper P.

The printer 1 employs an electro-thermal transfer method in which the ink i of the present embodiment is heated by the heating resistance elements 26a and ejected from the nozzles 27a, but the method is not limited to this, and, when employing an electromechanical transfer method in which the ink i is ejected electromechanically from nozzles using an electromechanical transfer element, such as a piezoelectric element, e.g., a piezo device, a similar effect is obtained.

### EXAMPLES

Hereinbelow, the ink of the present embodiment will be described.

Sample 1

Using an acetylenediol surfactant represented by the chemical formula (1) as a surfactant, and using Starfactant 20 (hyperbranched block copolymer) comprised of a branched polymer, manufactured and sold by Cognis Corporation, as a defoamer, the components shown in Table 1 below were mixed with one another, and subjected to filtration using a membrane filter having a pore size of 1.2 μm (Isopore, Millipore Corporation) to prepare an ink as a sample 1.

TABLE 1

| Components | wt % |
|---|---|
| C.I. Direct Blue 199 | 4.0 |
| Diethylene glycol | 10.0 |
| Glycerol | 10.0 |
| Compound represented by formula (1) wherein m + n | 0.5 |
| is 10, R¹ is an alkyl group having 4 carbon atoms, | |
| and R² is an alkyl group having 1 carbon atom. | |
| Starfactant 20 (Cognis Corporation) | 0.002 |
| Water | 75.5 |

Sample 2

As a sample 2, an ink was prepared using an acetylenediol surfactant represented by the chemical formula (1) as a surfactant in substantially the same manner as in the sample 1 except that FoamStar A10 comprised of a branched polymer, manufactured and sold by Cognis Corporation, was used as a defoamer, and the composition shown in Table 2 below was employed.

TABLE 2

| Components | wt % |
|---|---|
| C.I. Direct Blue 199 | 4.0 |
| Diethylene glycol | 10.0 |
| Glycerol | 10.0 |
| Compound represented by formula (1) wherein m + n | 0.5 |
| is 10, R¹ is an alkyl group having 4 carbon atoms, | |
| and R² is an alkyl group having 1 carbon atom. | |
| FoamStar A10 (Cognis Corporation) | 0.002 |
| Water | 75.5 |

Sample 3

As a sample 3, an ink was prepared using an acetylenediol surfactant represented by the chemical formula (1) as a surfactant in substantially the same manner as in the sample 1 except that FoamStar A12 comprised of a branched polymer, manufactured and sold by Cognis Corporation, was used as a defoamer, and the composition shown in Table 3 below was employed.

TABLE 3

| Components | wt % |
|---|---|
| C.I. Direct Blue 199 | 4.0 |
| Diethylene glycol | 10.0 |
| Glycerol | 10.0 |
| Compound represented by formula (1) wherein m + n | 0.5 |
| is 10, R¹ is an alkyl group having 4 carbon atoms, | |
| and R² is an alkyl group having 1 carbon atom. | |
| FoamStar A12 (Cognis Corporation) | 0.002 |
| Water | 75.5 |

Sample 4

As a sample 4, an ink was prepared using an acetylenediol surfactant represented by the chemical formula (1) as a surfactant in substantially the same manner as in the sample 1 except that FoamStar A32 comprised of a branched polymer, manufactured and sold by Cognis Corporation, was used as a defoamer, and the composition shown in Table 4 below was employed.

TABLE 4

| Components | wt % |
|---|---|
| C.I. Direct Blue 199 | 4.0 |
| Diethylene glycol | 10.0 |
| Glycerol | 10.0 |
| Compound represented by formula (1) wherein m + n | 0.5 |
| is 10, R¹ is an alkyl group having 4 carbon atoms, | |
| and R² is an alkyl group having 1 carbon atom. | |
| FoamStar A32 (Cognis Corporation) | 0.002 |
| Water | 75.5 |

Sample 5

As a sample 5, an ink was prepared using an acetylenediol surfactant represented by the chemical formula (1) as a surfactant in substantially the same manner as in the sample 1 except that FoamStar A32 comprised of a branched polymer, manufactured and sold by Cognis Corporation, was used as a defoamer, and the composition shown in Table 5 below was employed.

TABLE 5

| Components | wt % |
|---|---|
| C.I. Direct Blue 199 | 4.0 |
| Diethylene glycol | 10.0 |
| Glycerol | 10.0 |
| Compound represented by formula (1) wherein m + n | 0.5 |
| is 10, R¹ is an alkyl group having 4 carbon atoms, | |
| and R² is an alkyl group having 1 carbon atom. | |
| FoamStar A32 (Cognis Corporation) | 0.0001 |
| Water | 75.5 |

Sample 6

As a sample 6, an ink was prepared using an acetylenediol surfactant represented by the chemical formula (1) as a surfactant in substantially the same manner as in the sample 1 except that FoamStar A32 comprised of a branched polymer, manufactured and sold by Cognis Corporation, was used as a defoamer, and the composition shown in Table 6 below was employed.

TABLE 6

| Components | wt % |
|---|---|
| C.I. Direct Blue 199 | 4.0 |
| Diethylene glycol | 10.0 |
| Glycerol | 10.0 |
| Compound represented by formula (1) wherein m + n | 0.5 |
| is 10, R¹ is an alkyl group having 4 carbon atoms, | |
| and R² is an alkyl group having 1 carbon atom. | |
| FoamStar A32 (Cognis Corporation) | 0.01 |
| Water | 75.5 |

Sample 7

As a sample 7, an ink was prepared in substantially the same manner as in the sample 1 except that an acetylenediol surfactant represented by the chemical formula (2) was used as a surfactant, FoamStar A32 comprised of a branched polymer, manufactured and sold by Cognis Corporation, was used as a defoamer, and the composition shown in Table 7 below was employed.

TABLE 7

| Components | wt % |
|---|---|
| C.I. Direct Blue 199 | 4.0 |
| Diethylene glycol | 10.0 |
| Glycerol | 10.0 |
| Compound represented by formula (2) wherein R¹ | 0.1 |
| is an alkyl group having 4 carbon atoms, and R² | |
| is an alkyl group having 1 carbon atom. | |
| FoamStar A32 (Cognis Corporation) | 0.002 |
| Water | 75.9 |

Sample 8

As a sample 8, an ink was prepared using an acetylenediol surfactant represented by the chemical formula (1) as a surfactant in substantially the same manner as in the sample 1 except that a branched polymer as a defoamer was not used and the composition shown in Table 8 below was employed.

TABLE 8

| Components | wt % |
|---|---|
| C.I. Direct Blue 199 | 4.0 |
| Diethylene glycol | 10.0 |
| Glycerol | 10.0 |
| Compound represented by formula (1) wherein m + n | 0.5 |
| is 10, R¹ is an alkyl group having 4 carbon atoms, | |
| and R² is an alkyl group having 1 carbon atom. | |
| Water | 76.0 |

Sample 9

As a sample 9, an ink was prepared using an acetylenediol surfactant represented by the chemical formula (1) as a surfactant in substantially the same manner as in the sample 1 except that a branched polymer as a defoamer was not used and the composition shown in Table 9 below was employed.

TABLE 9

| Components | wt % |
|---|---|
| C.I. Direct Blue 199 | 4.0 |
| Diethylene glycol | 10.0 |
| 2-Propanol | 1.0 |
| Glycerol | 10.0 |
| Compound represented by formula (1) wherein m + n | 0.5 |
| is 10, R¹ is an alkyl group having 4 carbon atoms, | |
| and R² is an alkyl group having 1 carbon atom. | |
| Water | 75.0 |

Sample 10

As a sample 10, an ink was prepared using an acetylenediol surfactant represented by the chemical formula (1) as a surfactant in substantially the same manner as in the sample 1 except that a branched polymer as a defoamer was not used and the composition shown in Table 10 below was employed.

TABLE 10

| Components | wt % |
|---|---|
| C.I. Direct Blue 199 | 4.0 |
| Diethylene glycol | 10.0 |
| 2-Propanol | 3.0 |
| Glycerol | 10.0 |
| Compound represented by formula (1) wherein m + n | 0.5 |
| is 10, R¹ is an alkyl group having 4 carbon atoms, | |
| and R² is an alkyl group having 1 carbon atom. | |
| Water | 73.0 |

Sample 11

As a sample 11, an ink was prepared using an acetylenediol surfactant represented by the chemical formula (1) as a surfactant in substantially the same manner as in the sample 1 except that linear polyoxyalkylene alkyl ether (LEOCON1020H, Lion Corporation) was used as a defoamer, and the composition shown in Table 11 below was employed.

TABLE 11

| Components | wt % |
|---|---|
| C.I. Direct Blue 199 | 4.0 |
| Diethylene glycol | 10.0 |
| Glycerol | 10.0 |
| Compound represented by formula (1) wherein m + n | 0.5 |
| is 10, R¹ is an alkyl group having 4 carbon atoms, | |
| and R² is an alkyl group having 1 carbon atom. | |
| LEOCON 1020H (Lion Corporation) | 0.002 |
| Water | 75.5 |

Sample 12

As a sample 12, an ink was prepared using an acetylenediol surfactant represented by the chemical formula (1) as a surfactant in substantially the same manner as in the sample 1 except that polyoxyalkylene alkyl ether (SN Defoamer 777, San Nopco Limited) was used as a defoamer, and the composition shown in Table 12 below was employed.

TABLE 12

| Components | wt % |
|---|---|
| C.I. Direct Blue 199 | 4.0 |
| Diethylene glycol | 10.0 |
| Glycerol | 10.0 |
| Compound represented by formula (1) wherein m + n | 0.5 |
| is 10, R¹ is an alkyl group having 4 carbon atoms, | |
| and R² is an alkyl group having 1 carbon atom. | |
| SN Defoamer 777 (San Nopco Limited) | 0.002 |
| Water | 75.5 |

Sample 13

As a sample 13, an ink was prepared using an acetylenediol surfactant represented by the chemical formula (1) as a surfactant in substantially the same manner as in the sample 1 except that polyoxyalkylene alkyl ether (Antifroth F244, Dai-ichi Kogyo Seiyaku Co., Ltd.) was used as a defoamer, and the composition shown in Table 13 below was employed.

TABLE 13

| Components | wt % |
|---|---|
| C.I. Direct Blue 199 | 4.0 |
| Diethylene glycol | 10.0 |
| Glycerol | 10.0 |
| Compound represented by formula (1) wherein m + n | 0.5 |
| is 10, R¹ is an alkyl group having 4 carbon atoms, | |
| and R² is an alkyl group having 1 carbon atom. | |
| Antifroth F244 (Dai-ichi Kogyo Seiyaku Co., Ltd.) | 0.002 |
| Water | 75.5 |

Sample 14

As a sample 14, an ink was prepared in substantially the same manner as in the sample 1 except that an acetylenediol surfactant represented by the chemical formula (2) was used as a surfactant, FoamStar A32 comprised of a branched polymer, manufactured and sold by Cognis Corporation, was used as a defoamer, and the composition shown in Table 14 below was employed.

TABLE 14

| Components | wt % |
|---|---|
| C.I. Direct Blue 199 | 4.0 |
| Diethylene glycol | 10.0 |
| Glycerol | 10.0 |
| Compound represented by formula (2) wherein R¹ | 0.1 |
| is an alkyl group having 4 carbon atoms, and R² | |
| is an alkyl group having 1 carbon atom. | |
| FoamStar A32 (Cognis Corporation) | 0.02 |
| Water | 75.9 |

With respect to each of the above-prepared inks, a test for foaming power was conducted in accordance with JIS K3362-1970. Specifically, 50 ml of the ink was placed in a test tube in an environment at 25° C. to create a liquid level. Subsequently, using a pipette, 200 ml of the ink was allowed to fall from a height of 900 mm above the liquid level for 30 seconds, and, immediately after completion of the falling of the all ink, the amount of the bubbles generated was measured to determine foaming power. The test was conducted with respect to: A: the ink which had been just prepared; B: the ink which had been stored at 60° C. for 48 hours and then cooled to 25° C.; and C: the ink which had been stored at 60° C. for 120 hours and then cooled to 25° C. in each of the Examples and Comparative Examples. The results of the test are shown in Table 15 below.

TABLE 15

| | Foaming power (mm) | | |
|---|---|---|---|
| Sample | A | B | C |
| Sample 1 | 2 | 3 | 3 |
| Sample 2 | 5 | 23 | 30 |
| Sample 3 | 13 | 28 | 30 |
| Sample 4 | 5 | 14 | 12 |
| Sample 5 | 15 | 20 | 35 |
| Sample 6 | 4 | 5 | 5 |
| Sample 7 | 10 | 11 | 15 |
| Sample 8 | 33 | 52 | 73 |
| Sample 9 | 14 | 27 | 71 |
| Sample 10 | 13 | 18 | 68 |
| Sample 11 | 19 | 33 | 60 |
| Sample 12 | 11 | 29 | 53 |
| Sample 13 | 29 | 52 | 73 |
| Sample 14 | 2 | 6 | 5 |

As can be seen from the results shown in Table 15, the samples 1 to 7 containing an appropriate amount of a branched polymer as a defoamer and the sample 14 advantageously have small foaming power, as compared to the samples 8 to 10 containing no defoamer and the samples 11 to 13 containing a linear polymer.

It is found that each of the samples 1 to 7 and 14 contains a branched polymer as a defoamer, and hence is prevented from foaming both immediately after prepared and after stored in a high-temperature environment for a long time.

It is found that, in contrast to the above samples, each of the samples 8 to 10 contains no defoamer and hence generates bubbles even immediately after prepared, and is more likely to generate bubbles after stored in a high-temperature environment for a long time.

Further, it is found that each of the samples 11 to 13 contains a linear defoamer but generates bubbles even immediately after prepared, and is more likely to generate bubbles after stored in a high-temperature environment for a long time. This indicates that a defoaming effect may not be obtained in the samples 11 to 13 containing a linear defoamer like the sample containing no defoamer.

From the above, it is apparent that the ink containing a branched polymer is prevented from foaming both immediately after prepared and after stored in a high-temperature environment for a long time.

With respect to each sample of ink, a test for recovery from nozzle clogging was conducted. In the test for recovery from nozzle clogging, from the printer body of the above-described printer 1 (having a line head with a cross width of A4-size and having a nozzle density of 600 dpi), the head cartridge containing an ink jet head unified with an ink tank was removed, and the ink tank was individually filled with A: the recording liquid which had been just prepared; B: the recording liquid which had been stored at 60° C. for 48 hours and then cooled to 25° C.; and C: the recording liquid which had been stored at 60° C. for 120 hours and then cooled to 25° C. with respect to each of the Examples and Comparative Examples. Subsequently, the head cartridge was allowed to stand in a 10% RH environment at 25° C. for 10 minutes in a state such that the head cap of the printer was removed. Then, the number of the operations of head cleaning required until the all nozzles became ejectable was evaluated in accordance with the criteria shown below. The results of the test are shown in Table 16 below. In Table 16, symbol ◯ indicates that the number of the head cleaning operation is one, symbol Δ indicates that the number is 2 to 4, and symbol X indicates that the number is 5 or more.

TABLE 16

| | Recovery from nozzle clogging | | |
|---|---|---|---|
| Sample | A | B | C |
| Sample 1 | ◯ | ◯ | ◯ |
| Sample 2 | ◯ | Δ | Δ |
| Sample 3 | Δ | Δ | Δ |
| Sample 4 | ◯ | Δ | Δ |
| Sample 5 | Δ | Δ | Δ |
| Sample 6 | ◯ | ◯ | ◯ |
| Sample 7 | ◯ | ◯ | Δ |
| Sample 8 | Δ | X | X |
| Sample 9 | Δ | Δ | X |
| Sample 10 | Δ | Δ | X |
| Sample 11 | Δ | Δ | X |
| Sample 12 | Δ | Δ | X |
| Sample 13 | Δ | X | X |
| Sample 14 | ◯ | ◯ | Δ |

As can be seen from the results shown in Table 16, the samples 1 to 7 containing an appropriate amount of a branched polymer as a defoamer and the sample 14 make a quick recovery from nozzle clogging, as compared to the samples 8 to 10 containing no defoamer and the samples 11 to 13 containing a linear polymer.

Each of the samples 1 to 7 contains a branched polymer in an amount of 0.0001 to 0.01% by weight such that the branched polymer can prevent generation of bubbles, and hence each sample is prevented from generating bubbles. Therefore, in each of the samples 1 to 7, no bubbles go into the nozzles, and one operation of the cleaning enables ink ejection from the all nozzles.

It is found that, in contrast to the above samples, in the samples 8 to 13, no defoamer is contained or a linear defoamer is contained and hence bubbles are easily generated, and the bubbles generated go into the nozzles and 2 or more cleaning operations for the jet surface are required until ejection of the ink from the nozzles becomes possible, leading to an increase of the number of the cleaning operations for the jet surface. Further, it is found that each of the samples 8 to 13 is more likely to generate bubbles after stored in a high-temperature environment for a long time, and thus the number of the cleaning operations for the jet surface required until ejection of the ink from the nozzles becomes possible is inevitably further increased.

The sample 14 contains a branched polymer as a defoamer in an amount of 0.02% by weight, namely, contains a branched polymer in too large an amount, and the sample stored at a high temperature for a long time requires 2 to 4 cleaning operations for the jet surface until ejection of the ink from the nozzles becomes possible.

From the above, it is apparent that the ink containing an appropriate amount of a branched polymer is prevented from suffering nozzle clogging with bubbles, and can reduce the number of the cleaning operations for the jet surface, as compared to the ink containing no defoamer or containing a linear defoamer or too large an amount of a branched polymer, and regains a state in which the all nozzles are ejectable only by a single cleaning operation.

With respect to each of the inks in the Examples and Comparative Examples, a continuous printing test was conducted. In the continuous printing test, from the printer body of the above-described printer 1 (having a line head with a cross width of A4-size and having a nozzle density of 600 dpi), the head cartridge containing an ink jet head unified with an ink tank was removed, and the ink tank was filled with A: the recording liquid which had been just prepared with respect to each of the Examples and Comparative Examples. Then, the same image was continuously printed on A4-size plain paper in a 10% RH environment at 25° C., and the number of omitted nozzles was measured per printing on 1,000 sheets of paper. The results of the test are shown in Table 17 below. In Table 17, symbol ◯ indicates that the number of omitted nozzles is 0 to 10, symbol Δ indicates that the number of omitted nozzles is 11 to 49, and symbol X indicates that the number of omitted nozzles is 50 or more.

TABLE 17

| | Continuous printing test | | | | |
|---|---|---|---|---|---|
| | 1,000 | 2,000 | 3,000 | 4,000 | 5,000 |
| Sample | sheets | sheets | sheets | sheets | sheets |
| Sample 1 | ◯ | ◯ | ◯ | ◯ | ◯ |
| Sample 2 | ◯ | ◯ | ◯ | ◯ | Δ |
| Sample 3 | ◯ | ◯ | ◯ | ◯ | ◯ |
| Sample 4 | ◯ | ◯ | ◯ | ◯ | Δ |
| Sample 5 | ◯ | ◯ | ◯ | ◯ | ◯ |
| Sample 6 | ◯ | ◯ | ◯ | Δ | Δ |
| Sample 7 | ◯ | ◯ | ◯ | ◯ | Δ |
| Sample 8 | ◯ | ◯ | ◯ | ◯ | ◯ |
| Sample 9 | ◯ | ◯ | ◯ | ◯ | Δ |
| Sample 10 | ◯ | ◯ | ◯ | ◯ | Δ |
| Sample 11 | ◯ | ◯ | ◯ | ◯ | Δ |
| Sample 12 | ◯ | ◯ | ◯ | Δ | Δ |
| Sample 13 | ◯ | ◯ | ◯ | Δ | Δ |
| Sample 14 | ◯ | ◯ | Δ | X | X |

As can be seen from the results shown in Table 17, the samples 1 to 7 containing a branched polymer as a defoamer achieve continuous printing on a large number of sheets of paper, as compared to the samples 8 to 10 containing no defoamer, the samples 11 to 13 containing a linear polymer, and the sample 14 containing a large amount of a branched polymer as a defoamer.

It is found that each of the samples 1 to 7 contains an appropriate amount of a branched polymer and hence is prevented from generating bubbles and no bubbles go into the nozzles, and no nozzle omission is caused even in the continuous printing on a plurality of sheets of paper, thus achieving excellent ejection stability.

It is found that, in contrast to the above samples, in the samples 8 to 13, bubbles are generated and go into the nozzles to cause nozzle clogging, and the nozzles do not recover from clogging in the continuous printing and thus nozzle omission is caused, lowering the ejection stability.

It is found that the sample 14 contains too large an amount of a branched polymer, and hence causes nozzle omission in the continuous printing on about 3,000 sheets of paper, lowering the ejection stability.

From the above, it is apparent that the ink containing an appropriate amount of a branched polymer is prevented from generating bubbles and has excellent ejection stability, as compared to the ink containing no defoamer or containing a linear defoamer or too large an amount of a branched polymer, thus enabling continuous printing.

As can be seen from the results of the above foaming test, test for recovery from nozzle clogging, and continuous printing test, the inks of samples 8 to 10 containing no defoamer and the inks of samples 11 to 13 containing a linear defoamer have similar evaluations of the continuous printing test to those of the samples 1 to 7, but bubbles are generated in these samples and the bubbles generated make difficult recovery from nozzle clogging, thus increasing the number of the cleaning operations for the jet surface.

Further, the ink of sample 14 containing too large an amount of a branched polymer is prevented from generating bubbles, and has similar evaluations of the foaming test and test for recovery from nozzle clogging to those of the samples 1 to 7, but this ink causes nozzle omission in the continuous printing on about 3, 000 sheets of paper, which indicates that the ink has a problem in continuous printing.

In contrast to the above samples, the inks of samples 1 to 7 containing an appropriate amount of a branched polymer have excellent evaluations in each of the foaming test, the test for recovery from nozzle clogging, and the continuous printing test, and they are prevented from generating bubbles and no bubbles go into the nozzles, and the nozzles make a quick recovery from clogging and appropriate ejection of the ink is achieved only by a single cleaning operation to obtain excellent ejection stability, thus enabling continuous printing.

The present application contains subject matter related to Japanese Patent Application JP 2006-128638 filed in the Japanese Patent Office on May 2, 2007, the entire content of which being incorporated herein by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A recording liquid for use in recording on a recording medium, wherein the recording liquid is applied in form of droplets to the recording medium in the recording, the recording liquid comprising:
a solvent containing at least water and a water-soluble organic solvent;
a coloring material soluble or dispersible in the solvent;
a surfactant; and
a defoamer containing at least one kind of branched polymer.

2. The recording liquid according to claim 1, wherein the surfactant includes at least one kind of acetylenediol surfactant represented by the following chemical formula (1) or (2): 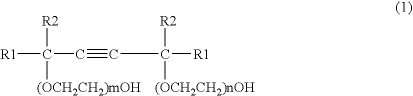
wherein each of R¹ and R² represents an alkyl group having 1 to 5 carbon atoms, and the following relationships are satisfied: 0<m≦25, 0<n≦25, and 0<m+n≦40, 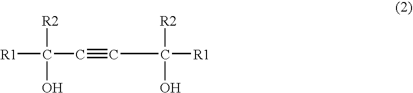
wherein each of R¹ and R² represents an alkyl group having 1 to 5 carbon atoms.

3. The recording liquid according to claim 1, wherein
the recording liquid is fed to a liquid ejection head provided in a liquid ejection apparatus and ejected in form of fine droplets from a plurality of ejection outlets formed in the liquid ejection head in response to a recording signal.

4. The recording liquid according to claim 3, wherein
the ejection outlets of the liquid ejection head are arranged in a substantially straight line extending in a width direction of the recording medium.

5. A recording method comprising ejecting fine droplets of a recording liquid from an ejection outlet, formed in a liquid ejection head, for ejecting the recording liquid onto a recording medium in response to a recording signal to perform recording,
wherein the recording liquid includes:
a solvent comprising at least water and a water-soluble organic solvent;
a coloringmaterial solubleordispersible in thesolvent;
a surfactant; and
a defoamer containing at least one kind of branched polymer.

6. The recording method according to claim 5, wherein the surfactant includes at least one kind of acetylenediol surfactant represented by the following chemical formula (1) or (2): 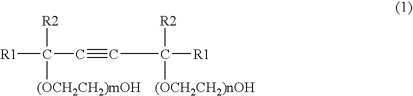
wherein each of R¹ and R² represents an alkyl group having 1 to 5 carbon atoms, and the following relationships are satisfied: 0<m≦25, 0<n≦25, and 0<m+n≦40, 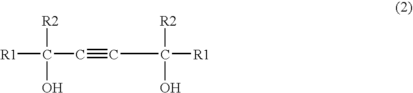
wherein each of R¹ and R² represents an alkyl group having 1 to 5 carbon atoms.

7. The recording method according to claim 5, wherein
the ejection outlets of the liquid ejection head are arranged in a substantially straight line extending in a width direction of the recording medium.

8. The recording method according to claim 5, wherein
the recording method includes multicolor recording using the recording liquids having a plurality of colors.

9. A liquid cartridge including a recording liquid for use in recording on a recording medium, wherein the recording liquid is applied in form of droplets to the recording medium in the recording,
wherein the recording liquid includes:
a solvent containing at least water and a water-soluble organic solvent;
a coloring material soluble or dispersible in the solvent;
a surfactant; and
a defoamer containing at least one kind of branched polymer.

10. The liquid cartridge according to claim 9, wherein
the surfactant includes at least one kind of acetylenediol surfactant represented by the following chemical formula (1) or (2): 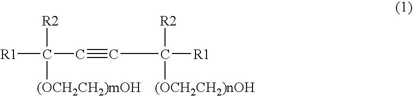
wherein each of R¹ and R² represents an alkyl group having 1 to 5 carbon atoms, and the following relationships are satisfied: 0<m≦25, 0<n≦25, and 0<m+n≦40, 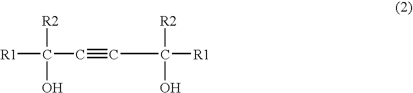
wherein each of R¹ and R² represents an alkyl group having 1 to 5 carbon atoms.
